(19) United States
(12) Patent Application Publication
(10) Pub. No.: US 2026/0005901 A1
(43) Pub. Date: Jan. 1, 2026

(54) SENSING AND/OR COMMUNCATION IN A NETWORK BASED ON AFFINE FREQUENCY DIVISION MULTIPLEXING

(71) Applicant: HUAWEI TECHNOLOGIES CO., LTD., Shenzhen (CN)

(72) Inventors: Ali Bemani, Boulogne Billancourt (FR); Nassar KSAIRI, Boulogne Billancourt (FR)

(73) Assignee: HUAWEI TECHNOLOGIES CO., LTD., Shenzhen (CN)

(21) Appl. No.: 19/316,484

(22) Filed: Sep. 2, 2025

Related U.S. Application Data
(63) Continuation of application No. PCT/EP2023/055405, filed on Mar. 3, 2023.

(51) Int. Cl. H04L 27/10; H04L 25/02; H04L 27/26

(52) U.S. Cl. CPC H04L 27/103; H04L 25/0204; H04L 27/2628; H04L 27/2639

(57) ABSTRACT

The present disclosure relates to sensing and/or communication in a network. The disclosure proposes a sensing device, a sensing device transmitter, a sensing device receiver, a network device, a network, and corresponding methods for operating said devices. The sensing device is configured to generate an affine frequency division multiplexing (AFDM) signal comprising a set of chirp carriers that are orthogonal in a discrete affine Fourier transform (DAFT) domain, and transmit the AFDM signal, wherein the set of chirp carriers is generated based on an inverse discrete affine Fourier transform (IDAFT) and wherein the set of chirp carriers comprises a first subset of chirp carriers that are pilot signals for sensing, and a second subset of chirp carriers that are nulled.

### CROSS-REFERENCE TO RELATED APPLICATIONS

This application is a continuation of International Application No. PCT/EP2023/055405, filed on Mar. 3, 2023, the disclosure of which is hereby incorporated by reference in its entirety.

### TECHNICAL FIELD

The present disclosure relates to sensing and/or communication in a network. The disclosure proposes a sensing device, a sensing device transmitter, a sensing device receiver, a network device, a network, and corresponding methods for operating said devices. The sensing device is configured to transmit a new kind of signal for sensing and/or communication in the network.

### BACKGROUND

One of the projected requirements for 6G waveforms is support for sensing as a service. Sensing as a service refers to providing to user devices either network sensing or network-supported/coordinated sensing. This is to be done both for conventional applications e.g., driving radars, and less conventional ones e.g., radio frequency (RF)-based reconstruction of the real-time environment and building the result into artificial intelligence (AI) services. The wireless waveforms underlying the communications network should yield good sensing performance while being subject to resource allocation and other constraints imposed by the network providing sensing as a service, e.g., to limit interference between sensing signals. Indeed, having multiple devices using the sensing service in a same cell area means that said devices will be all transmitting sensing/probing signals and thus potentially generating interference for each other and for other devices in their vicinity. Thus, sensing should be network-supported or network-coordinated. Since the devices intended to use the sensing service are also communications devices, network support for sensing may also include support for integrated sensing and communications (ISAC) from those devices.

Generally, channel estimation is based on pilot signals, which are signals known to receiving devices, that are inserted in a transmitted signal such that those receiving devices can estimate the effect of the propagation channel on the transmitted signal. In long-term evolution (LTE) and new-radio (NR) systems, downlink pilots include downlink demodulation reference signals (DMRS) and channel state information reference signals (CSI-RS) while uplink pilots include uplink DMRS and sounding reference signals (SRS).

Conventional chirp-based frequency modulated continuous-wave (FMCW) radars are known for good sensing performance at low processing complexity. However, FMCW is ill-suited for ISAC. Indeed, only suboptimal solutions in terms of resource utilization efficiency have been proposed to integrate FMCW sensing with data communications, for example, time-division multiplexing (TDM) of FMCW and communications signals. However, TDM entails high overhead.

ISAC solutions based on waveforms such as Orthogonal Frequency-Division Multiplexing (OFDM) and Orthogonal Time Frequency Space (OTFS) can achieve similar range and velocity resolutions and root mean squared error (RMSE) performance as FMCW radars while simultaneously supporting transmitting data to communications receivers. However, as opposed to FMCW radars, these solutions require the implementation of a costly, for example, a costly full duplex, analog cancellation operation to remove direct-path self-interference that would blind the sensing receiver's analog-to-digital converter (ADC). In FMCW, only a simple direct current (DC) blocking module is needed for self-interference cancellation (SIC).

### SUMMARY

In view of the above, an objective of this disclosure is to provide efficient sensing, communication, and/or channel estimation. Another objective is to support at least one of the following features: resource-efficient multiplexing with other sensing signal sources; ISAC; resource-efficient and/or low-complexity MIMO sensing; and self-interference cancellation.

These and other objectives are achieved by this disclosure as described in the enclosed independent claims. Advantageous implementations are further defined in the dependent claims.

The disclosure is based on the following considerations. Orthogonal chirp division multiplexing (OCDM) and affine frequency division multiplexing (AFDM) can provide new multi-chirp waveforms for wireless communications. OCDM is generated using the discrete Fresnel transform (DFnT), while AFDM is based on the discrete affine Fourier transform (DAFT), a linear transform characterized by a couple of parameters (c₁, c₂), of which the DFnT is a special case. AFDM being “based on DAFT” may refer to that the transmitter uses an inverse discrete affine Fourier transform (IDAFT) to map the symbols at its input to discrete-time chirps parametrized with (c₁, c₂) at its output. This is analogous to how OFDM is based on the discrete Fourier transform (DFT), as the OFDM transmitter uses the inverse discrete Fourier transform (IDFT) to map symbols at its input to frequency subcarriers at its output. AFDM can achieve the full diversity of linear time-varying (LTV) channels with low pilot overhead.

One of the main advantages of multi-chirp signals in general and of AFDM signals in particular is the channel estimation performance that can be achieved based on chirp pilots. Since multi-chirp AFDM signals are based on DAFT, each chirp pilot of an AFDM signal is equivalently a DAFT domain symbol. As few as one DAFT domain symbol used as a pilot may yield, when appended with a sufficient number of zero guard samples, a full delay-Doppler representation of the wireless channel, i.e., the possibility to identify all the delay and Doppler components associated with the propagation medium. This is evidently relevant for sensing and radar applications since the delay-Doppler representation of the wireless channel associated with the round-trip propagation from the wireless transmitter to the targets in its vicinity and back to the transmitter translates into range-velocity information about those targets.

For sensing with multiple antennas, multiple radar signals may be generated that are mutually orthogonal, wherein each radar signal may be associated with one transmission antenna or spatial beam. The same applies to the multi-radar case where multiple sensing devices are in the same area and their mutual interference should be kept to a minimum. For MIMO FMCW or multi-radar FMCW, one solution may be to allow overlapping in time of successive time-shifted chirps belonging to different transmitters while orthogonality is achieved by filtering in the intermediate-frequency (IF) domain assuming that a sufficiently long guard interval separates each two subsequent chirps. However, the “analog” nature of FMCW chirps means that there is an excess in resource utilization (time in the case of the time-shifted scheme of). Embodiments of this disclosure are based on an AFDM waveform, which provides an efficient solution to this resource inefficiency.

A first aspect of this disclosure provides a sensing device transmitter, wherein the sensing device transmitter is configured to generate an AFDM signal comprising a set of chirp carriers that are orthogonal in a DAFT domain, and transmit the AFDM signal, wherein the set of chirp carriers is generated based on an IDAFT, and wherein the set of chirp carriers comprises a first subset of chirp carriers that are pilot signals for sensing, and a second subset of chirp carriers that are nulled.

The sensing device transmitter may be a wireless sensing device transmitter, for example, for wireless sensing and/or wireless communication.

The second subset of chirp carriers may be used as sensing pilots or data carriers by other sensing device transmitters in the network and/or a same cell area.

Each chirp carrier of the set of chirp carriers may occupy an entire frequency spectrum and an entire duration of the AFDM signal.

The sensing device transmitter may provide resource-efficient multiplexing with other sensing signal sources.

The sensing device transmitter may be comprised in a sensing device.

In an implementation form of the first aspect, the set of chirp carriers further comprises a third subset of chirp carriers for data transmission and/or control messages transmission.

The sensing device transmitter may provide efficient, for example, resource efficient, ISAC.

In a further implementation form of the first aspect, the sensing device transmitter is configured to obtain a pair of DAFT parameters for parametrizing the set of chirp carriers, wherein the AFDM signal is generated further based on the pair of DAFT parameters.

The pair of DAFT parameters may be for determining the IDAFT used by the sensing device transmitter.

In a further implementation form of the first aspect, the sensing device transmitter is configured to obtain a pair of DAFT parameters and/or assignment information, and determine at least two of: the first subset of chirp carriers, the second subset of chirp carriers, and the third subset of chirp carriers, based on the assignment information and/or the pair of DAFT parameters.

The assignment information may be obtained and/or received from a network device. The assignment information may be predetermined and/or stored at the sensing device transmitter.

The sensing device transmitter may be configured to assign based on the assignment information each chirp carrier of the set of chirp carriers of the AFDM signal to one of: the first set of chirp carriers, the second set of chirp carriers, and the third subset of chirp carriers.

Each chirp carrier of the set of chirp carriers may be associated with an index, wherein the index of the chirp carrier designates an input position of an input symbol of the IDAFT that corresponds to said chirp carrier.

The assignment information may comprise a first subset of indexes, e.g., for designating input positions of a first subset of pilot symbols, a second subset of indexes, e.g., for designating input positions of a second subset of null symbols, and a third subset of indexes, e.g., for designating input positions of a third subset of data symbols.

The sensing device transmitter may be further configured to generate at least two of: the first subset of chirp carriers, the second subset of chirp carriers, and the third subset of chirp carriers based on respectively the first subset of indexes, the second subset of indexes, and the third subset of indexes.

In a further implementation form of the first aspect, the pair of DAFT parameters comprises a first parameter, which indicates a slope of the chirp carriers of the set of chirp carriers, the slope being defined by a linear frequency variation of each chirp carrier of the set of chirp carriers over time.

In a further implementation form of the first aspect, the pair of DAFT parameters further comprises a second parameter, which indicates a diagonal matrix to be used by the sensing device transmitter to adjust a waveform of the AFDM signal.

In a further implementation form of the first aspect, the sensing device transmitter is configured to: obtain a set of input symbols comprising at least two of a first subset of pilot symbols, a second subset of null symbols, and a third subset of data symbols, map the set of input symbols to the set of chirp carriers parametrized with the pair of DAFT parameters by applying the IDAFT.

In a further implementation form of the first aspect, each input symbol of the first subset of pilot symbols corresponds to a chirp carrier of the first subset of chirp carriers and is surrounded in the DAFT domain by a number of null symbols of the second subset of null symbols corresponding to the second subset of chirp carriers forming a respective buffer interval for the chirp carrier of the first subset of chirp carriers.

For example, the respective buffer interval may be larger than 0 in the DAFT domain.

In a further implementation form of the first aspect, each chirp carrier and/or a respective guard interval of the chirp carrier of the set of chirp carriers does not overlap in the DAFT domain with any other chirp carrier of the set of chirp carriers and/or a respective guard interval of the other chirp carrier.

In a further implementation form of the first aspect, the number of null symbols for each input symbol from the first subset of pilot symbols is equal to at least 2N_{DAFT}c₁(L−1)+2Q, wherein L−1 is a round-trip delay in samples associated with a target at the maximum range to be supported by the sensing device transmitter, wherein a first parameter of the pair of DAFT parameters is

$${c}_{1} = \frac{1 + 2 Q}{2 {N}_{DAFT}} ,$$

wherein Q is a normalized Doppler frequency shift in samples associated with a target at the maximum relative speed with the sensing device transmitter to be supported by that device, wherein N_{DAFT} is a predetermined system parameter equal to the size of the DAFT which is also a number of chirp carriers of the set of chirp carriers.

In a further implementation form of the first aspect, the sensing device transmitter comprises a plurality of transmit antennas, wherein the sensing device transmitter is configured to assign each chirp carrier of the first subset of chirp carriers to a different antenna of the plurality of antennas and/or to a different spatial beam jointly formed by said plurality of antennas to be transmitted exclusively through said antenna or said spatial beam.

The plurality of transmit antennas may comprise physical antennas and/or antenna ports.

The sensing device transmitter may further be configured to assign each chirp carrier of the set of chirp carriers to a different antenna of the plurality of antennas and/or to a different spatial beam jointly formed by said plurality of antennas to be transmitted exclusively through said antenna or said spatial beam. Each chirp carrier of the second set of chirp carriers may not be transmitted as said chirp carriers are nulled. Some antennas or spatial beams may be assigned to the second set of chirp carriers and may not be used or not communicate data with the sensing device transmitter.

The sensing device transmitter may provide resource-efficient and/or low-complexity MIMO sensing.

In a further implementation form of the first aspect, the sensing device transmitter is configured to transmit a sensing resource request message to a network device, and receive the pair of DAFT parameters and/or the assignment information as a response to the request.

The sensing resource request message may be transmitted using at least some chirp carriers of the set of chirp carriers of the AFDM signal.

In a further implementation form of the first aspect, each chirp carrier of the set of chirp carriers is associated with a respective different chirp.

A second aspect of this disclosure provides a sensing device receiver, wherein the sensing device receiver is configured to: receive an AFDM signal comprising a set of chirp carriers that are orthogonal in a DAFT domain, wherein the set of chirp carriers comprises a first subset of chirp carriers that are pilot signals for sensing, and a second subset of chirp carriers that are nulled; and generate an output signal based on the AFDM signal.

The set of chirp carriers may be generated based on an IDAFT.

The sensing device receiver may be a wireless sensing device receiver, for example, for wireless receiving and/or wireless communication.

The sensing device receiver may be comprised in a sensing device.

The sensing device receiver may be comprised in a network of two or more sensing devices and/or a network device.

The AFDM signal may be received from multiple sensing devices or only from one sensing device of the two or more sensing devices. The AFDM signal may be received from the network device.

The AFDM signal may comprise multiple respective AFDM signals from different sensing devices and/or the network device.

In an implementation form of the second aspect, the sensing device receiver is further configured to obtain a chirp local oscillator, down-convert the AFDM signal, for example, the first subset of chirp carriers or the pilot signals, using the chirp local oscillator to generate a down-converted output that is based on at least the first subset of chirp carriers, block the direct current, DC, component of the down-converted output to generate a blocked output, wherein the sensing device receiver further comprises a continuous-time filter configured to filter the blocked output to generate the output signal.

The sensing device receiver may provide self-interference cancellation.

In a further implementation form of the second aspect, the AFDM signal is received through at least one channel, and wherein the sensing device receiver is further configured to generate channel estimation information of the at least one channel based on the output signal.

In a further implementation form of the second aspect, the receiver is further configured to generate, with the at least one channel, range and/or relative speed estimates about one or more targets in an environment surrounding the receiver based on the channel estimation information.

The sensing device may generate said estimates, wherein the receiver may be comprised in the sensing device. Generating said estimates may comprise transmitting and receiving signals through the at least one channel to and from the one or more targets.

In a further implementation form of the second aspect, the set of chirp carriers further comprises a third subset of chirp carriers for data transmission and/or control messages transmission.

In a further implementation form of the second aspect, the AFDM signal comprises a set of AFDM multi-chirp symbols, wherein the sensing device receiver comprises a radio frequency, RF, down-converter configured to down-convert the AFDM signal, and wherein the sensing device receiver is configured to: designate one chirp carrier of the set of chirp carriers as a reference chirp carrier, wherein the chirp local oscillator comprises a set of periodic chirp segments, wherein each chirp segment of the set of periodic chirp segments is synchronized in time and frequency with the reference chirp carrier in one AFDM symbol of the set of AFDM multi-chirp symbols, feed the RF down-converter with the chirp local oscillator to generate a set of multi-frequency-tone signal segments, each segment of the set of multi-frequency-tone signal segments corresponding to an AFDM symbol of the set of AFDM multi-chirp symbols, and block the DC component of the down-converted output to remove or attenuate direct-path interference resulting from a part of the AFDM signal modulating the reference chirp carrier, wherein the continuous-time filter is configured to filter the blocked output to remove or attenuate direct-path interference corresponding to tones of the down-converted output resulting from a part of the AFDM signal modulating other chirp carriers of the set of chirp carriers.

A third aspect of this disclosure provides a network device for coordinating a network of two or more sensing devices, wherein the network device is configured to: obtain a pair of DAFT parameters for parametrizing a set of chirp carriers that are orthogonal in DAFT domain, determine, for each sensing device of the two or more sensing devices, respective assignment information, transmit the pair of DAFT parameters to the two or more sensing devices, transmit, for each sensing device of the two or more sensing devices, the respective assignment information to the sensing device, wherein, for each sensing device of the two or more sensing devices, the respective assignment information indicates a partition of the set of chirp carriers into at least a first subset of chirp carriers that are pilot signals for sensing, and a second subset of chirp carriers that are nulled.

The network device may be a wireless network device, for example, for wireless communication.

The set of chirp carriers may be determined based on the DAFT parameters.

The network device may comprise a sensing device.

The pair of DAFT parameters may be for determining the DAFT used by the two or more sensing devices. The set of chirp carriers is associated with the two or more sensing devices. For example, the two or more sensing device may respectively generate an AFDM signal comprising the set of chirp carriers.

Determining the assignment information may be based on the pair of DAFT parameters and/or by evenly allocating chirp carriers comprised in the entire set of chirp carriers to each sensing device of the two or more sensing devices. Each sensing device may use its respective allocated chirp carriers for sensing and/or communication.

The assignment information may be for minimizing or reducing interference between the two or more network devices.

In an implementation form of the third aspect, for each sensing device of the two or more sensing devices, the respective assignment information indicates a partition of the set of chirp carriers into at least the first subset of chirp carriers, the second subset of chirp carriers, and a third subset of chirp carriers for data transmission and/or control messages transmission.

In a further implementation form of the third aspect, for each sensing device of the two or more sensing devices, the first subset of chirp carriers is entirely different from at least one of: a respective first subset of chirp carriers of each other sensing device of the two or more sensing devices, and a respective third subset of chirp carriers of each other sensing device of the two or more sensing devices.

In a further implementation form of the third aspect, the network device is configured to receive a sensing resource request message from at least one sensing device of the two or more sensing devices, obtain the pair of DAFT parameters and/or determine the assignment information as a response to the sensing resource request message.

In a further implementation form of the third aspect, the network device is configured to obtain capability information indicating one or more capability parameters of the two or more sensing devices, wherein determining the respective assignment information for each sensing device of the two or more sensing devices is based on the capability information.

For example, the network device may obtain resource information, for example, resource capacity and resource utilization information of resources associated with the two or more sensing devices, about the network to determine the assignment information.

A fourth aspect of this disclosure provides a sensing device comprising a sensing device transmitter according to the first aspect or one of the implementation forms of the first aspect and a sensing device receiver according to the second aspect or one of the implementation forms of the second aspect.

In an implementation form of the fourth aspect, the sensing device is further configured to generate, with the at least one channel, range and/or relative speed estimates about one or more targets in an environment surrounding the sensing device based on the channel estimation information.

Generating said estimates may comprise transmitting and receiving signals through the at least one channel to and from the one or more targets.

The sensing device of the fourth aspect and its implementation forms achieve the advantages and effects described above for the sensing device transmitter of the first aspect, the sensing device receiver of the second aspect, and its respective implementation forms.

A fifth aspect of this disclosure provides a network comprising two or more sensing devices each according to the fourth aspect or one of the implementation forms of the fourth aspect, and a network device according to the third aspect or one of the implementation forms of the third aspect.

The network of the fifth aspect may have implementation forms that correspond to the implementation forms of the sensing device of the fourth aspect and the network device of the third aspect. The network of the fifth aspect and its implementation forms achieve the advantages and effects described above for the sensing device transmitter of the first aspect, the sensing device receiver of the second aspect, the network device of the third aspect, the sensing device of the fourth aspect, and its respective implementation forms.

A sixth aspect of this disclosure provides a method of operating a sensing device transmitter. The method comprises generating an AFDM signal comprising a set of chirp carriers that are orthogonal in a DAFT domain, and transmitting the AFDM signal, wherein the set of chirp carriers is generated based on an IDAFT and wherein the set of chirp carriers comprises a first subset of chirp carriers that are pilot signals for sensing, and a second subset of chirp carriers that are nulled.

The method of the sixth aspect may have implementation forms that correspond to the implementation forms of the sensing device transmitter of the first aspect. The method of the sixth aspect and its implementation forms achieve the advantages and effects described above for the sensing device transmitter of the first aspect and its respective implementation forms.

A seventh aspect of this disclosure provides a method of operating a sensing device receiver. The method comprises receiving an AFDM signal comprising a set of chirp carriers that are orthogonal in a DAFT domain, wherein the set of chirp carriers comprises a first subset of chirp carriers that are pilot signals for sensing, and a second subset of chirp carriers that are nulled; and generating an output signal based on the AFDM signal.

The method of the seventh aspect may have implementation forms that correspond to the implementation forms of the sensing device receiver of the second aspect. The method of the seventh aspect and its implementation forms achieve the advantages and effects described above for the sensing device receiver of the second aspect and its respective implementation forms.

An eighth aspect of this disclosure provides a method of operating a network device for coordinating a network of two or more sensing devices. The method comprises obtaining a pair of DAFT parameters for parametrizing a set of chirp carriers that are orthogonal in DAFT domain, determining, for each sensing device of the two or more sensing devices, respective assignment information, transmitting the pair of DAFT parameters to the two or more sensing devices, transmitting, for each sensing device of the two or more sensing devices, the respective assignment information to the sensing device, wherein, for each sensing device of the two or more sensing devices, the respective assignment information indicates a partition of the set of chirp carriers into at least a first subset of chirp carriers that are pilot signals for sensing, and a second subset of chirp carriers that are nulled.

The method of the eighth aspect may have implementation forms that correspond to the implementation forms of the network device of the third aspect. The method of the eighth aspect and its implementation forms achieve the advantages and effects described above for the network device of the third aspect and its respective implementation forms.

A ninth aspect of this disclosure provides a method of operating a sensing device. The method comprises the method of the fifth aspect or one of the implementation forms of the fifth aspect and the method of the sixth aspect or one of the implementation forms of the sixth aspect.

The method of the ninth aspect may have implementation forms that correspond to the implementation forms of the sensing device of the fourth aspect. The method of the ninth aspect and its implementation forms achieve the advantages and effects described above for the sensing device of the fourth aspect and its respective implementation forms.

Further, in this disclosure the phrase “null symbols” and “zero guard samples” may be used interchangeably.

Further, in this disclosure the phrase “guard interval” and “buffer interval” may be used interchangeably.

It has to be noted that all devices, elements, units and means described in the disclosure could be implemented in the software or hardware elements or any kind of combination thereof. All steps which are performed by the various entities described in the disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings.

FIG. 1 shows a sensing device transmitter according to this disclosure.

FIG. 2 shows a sensing device receiver according to this disclosure.

FIG. 3 shows a network device according to this disclosure.

FIG. 4 shows AFDM-based sensing in the case of two transmitters according to this disclosure.

FIG. 5 shows a time-frequency representation of an AFDM-based ISAC waveform according to this disclosure.

FIG. 6 shows a wireless communication system according to this disclosure.

FIG. 7 shows AFDM MIMO sensing device transmitter architecture for sensing and/or integrated sensing and communications according to this disclosure.

FIG. 8 shows a sensing device receiver according to this disclosure.

FIG. 9 shows a time-frequency representation of an exemplary output of analog de-chirping in the case of an AFDM signal with two active chirp sub-carriers according to this disclosure.

FIG. 10 shows a method according to an embodiment of this disclosure.

FIG. 11 shows a method according to an embodiment of this disclosure.

FIG. 12 shows a method according to an embodiment of this disclosure.

### DETAILED DESCRIPTION OF EMBODIMENTS

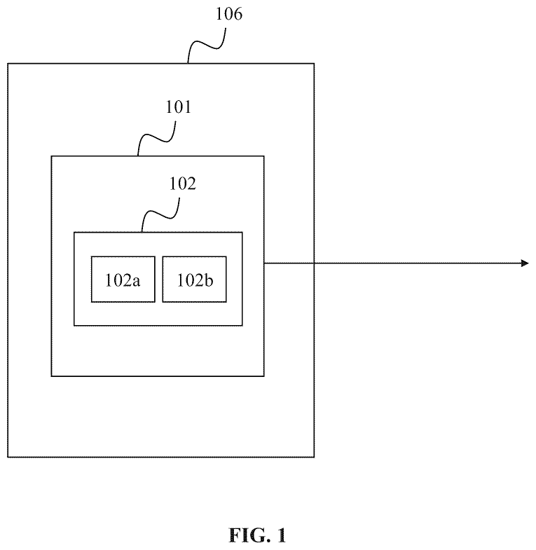

FIG. 1 shows a sensing device transmitter 106 according to this disclosure. The sensing device transmitter 106 is configured to generate an AFDM signal 101 comprising a set of chirp carriers 102 that are orthogonal in a DAFT domain. The set of chirp carriers 102 is generated based on an IDAFT and the set of chirp carriers 102 comprises a first subset of chirp carriers 102a that are pilot signals for sensing, and a second subset of chirp carriers 102b that are nulled. Further, the sensing device transmitter 106 is configured transmit the AFDM signal 101.

The sensing device transmitter 106 may transmit the AFDM signal 101 to a sensing device receiver 103 and/or a network device 200.

The sensing device transmitter 106 may comprise one or more IDAFT modules for generating the set of chirp carriers 102 and/or the AFDM signal 101.

An AFDM signal 101 transmitted by the sensing device transmitter 106 for wireless sensing may be generated by frequency up-converting an output of an IDAFT module fed with a vector of complex values that contains at least one non-zero entry. The vector may comprise a set of input symbols. For example, the vector may comprise at least two of a first subset of pilot symbols, a second subset of null symbols, and a third subset of data symbols.

The sensing device transmitter 106 may be comprised in a sensing device 100.

The above features of the sensing device transmitter 106 may be part of a transmitter part or transmitter side of the sensing device 106. The sensing device 106 may further comprise a receiver 103 part or sensing device receiver 103 side.

The sensing device transmitter 106 may be an ISAC device, i.e., a sensing device transmitter 106 capable of communications, that generates the AFDM signal 101 comprising a first subset of chirp carriers 102a that are pilot signals dedicated to sensing or to sensing at the transmitter side and to channel estimation at the sensing device receiver 103 side, a third subset of chirp carriers 102c used both for data and control transmission to a communications sensing device receiver 103 device 103, and a second subset of chirp carriers 102b that are nulled, for example, left empty to be used as sensing pilots or data carriers by other ISAC devices in a same cell area.

When analysed in the DAFT domain (of appropriate parameters), the AFDM signals 101 according to embodiments of this disclosure may be composed of identifiable finite-support segments separated by guard intervals.

When analyzed per antenna or in the spatial beam domain, the finite-support DAFT domain segments of the sensing signals pertaining to different antennas or beams may be non-overlapping.

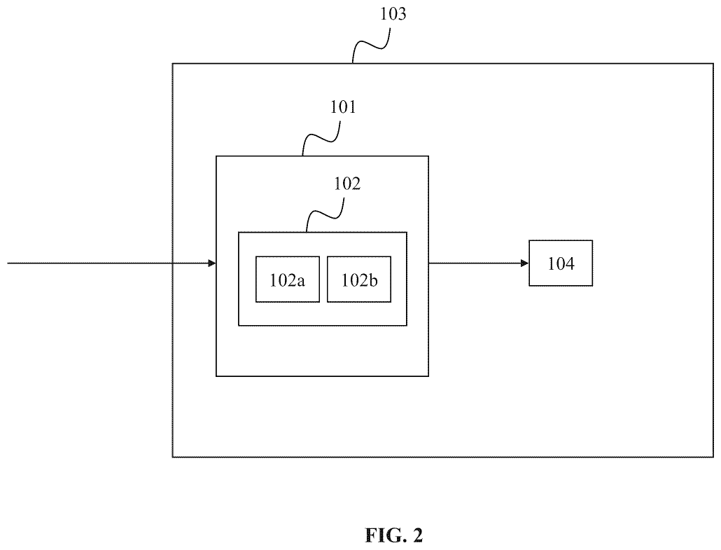

FIG. 2 shows a sensing device receiver 103 according to this disclosure. The sensing device receiver 103 is configured to receive an AFDM signal 101 comprising a set of chirp carriers 102 that are orthogonal in a DAFT domain. The set of chirp carriers 102 comprises a first subset of chirp carriers 102a that are pilot signals for sensing, and a second subset of chirp carriers 102b that are nulled. The sensing device receiver 103 is further configured to generate an output signal based on the AFDM signal 101.

The sensing device receiver 103 may be comprised in a sensing device 100. The sensing device 100 may comprise a sensing device receiver 103 part and a transmitter part.

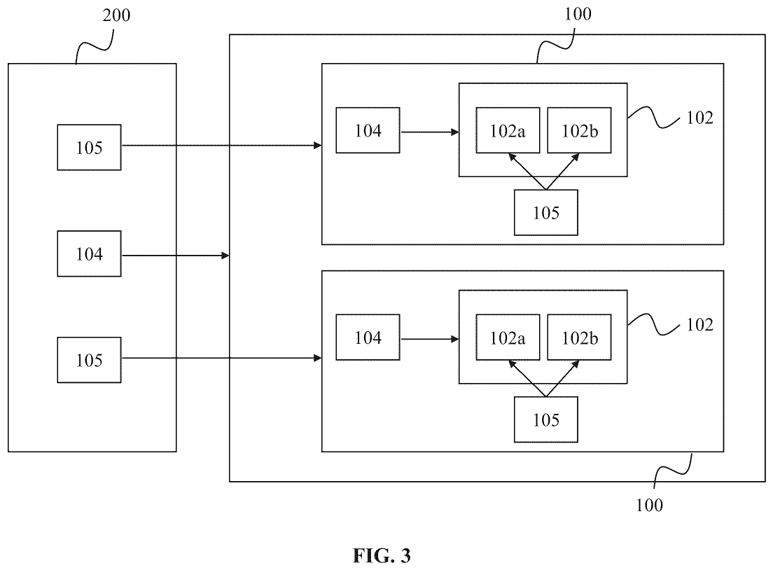

FIG. 3 shows a network device 200 according to this disclosure. The network device 200 is for coordinating a network of two or more sensing devices 100. The network device 200 is configured to obtain a pair of DAFT parameters 104 for parametrizing a set of chirp carriers 102 that are orthogonal in DAFT domain, and determine, for each sensing device 100 of the two or more sensing devices 100, respective assignment information 105. Further, the network device 200 is configured to transmit the pair of DAFT parameters 104 to the two or more sensing devices 100, transmit, for each sensing device 100 of the two or more sensing devices 100, the respective assignment information 105 to the sensing device 100. For each sensing device 100 of the two or more sensing devices 100, the respective assignment information 105 indicates a partition of the set of chirp carriers 102 into at least a first subset of chirp carriers 102a that are pilot signals for sensing, and a second subset of chirp carriers 102b that are nulled.

Two or more sensing devices 100 and a network device 200 may form a network. The network device 200 may comprise a sensing device 100.

The network device 200 may be responsible for setting the values of (c₁, c₂) of a DAFT pair 104 for the underlying DAFT used by the two or more sensing devices 100, for example, all the sensing devices 100 in a cell area, and for coordinating the assignment of the specific chirp carriers used by each AFDM sensing device 100 so that interference is reduced and/or minimized among them.

Embodiments of this disclosure are based on AFDM, for example, a transmitter using an IDAFT module to generate time-domain samples of AFDM signals 101 to be propagated on a wireless channel for communication and/or sensing.

In FMCW radars that are configured for a target range and a target velocity resolution, and/or a target maximum range and target maximum velocity, a sensing signal transmitted by one radar transmitter, e.g., one antenna of one radar device or one spatial beam formed jointly by all the antennas of that device, may comprise a corresponding number successive non-overlapping segments of chirps, each with a corresponding chirp rate i.e., a corresponding slope in the time-frequency plan. Multiple consecutive chirps (per spatial beam or antenna) may be needed to decouple velocity from range.

On the other hand, AFDM signals 101 according to this disclosure can be configured with the same frequency bandwidth as that of the above FMCW signal, wherein a selection of DAFT parameters (c₁, c₂) 104 allows for using as few as one chirp carrier (per spatial beam or antenna). This is the case because one DAFT-domain symbol i.e., one chirp carrier, may be sufficient to provide a full delay-Doppler channel representation, if the parameter c₁ of the underlying DAFT is set as

$${c}_{1} = ∓ \frac{1 + 2 Q}{2 {N}_{DAFT}}$$

with a large enough Q and provided that the DAFT-domain symbol is surrounded by a sufficient number of DAFT-domain zero guard samples equal to at least (2Q+1)L−1. L may be a round-trip delay in samples associated with a target at the maximum range to be supported. This number of zero guard samples is explained by the fact that the (c₁, c₂)-DAFT-domain input-output relation to a time-varying channel

$$( {h}_{k , {l}_{p}} = {\sum }_{q = - Q}^{Q} {α}_{p , q} {e}^{i 2 π \frac{qk}{N}} ,$$

with delays lₚ∈{0 . . . L−1} and Doppler spread 2Q+1) in AFDM is the impulse response of an equivalent channel with delays=(1+2Q)lₚ+q for q∈{−Q, . . . , Q}.

The second set of chirp carriers 102 are nulled and/or left empty and may be used as sensing pilots and/or for data transmission and/or control messages transmission by other sensing device transmitters 106 in the vicinity.

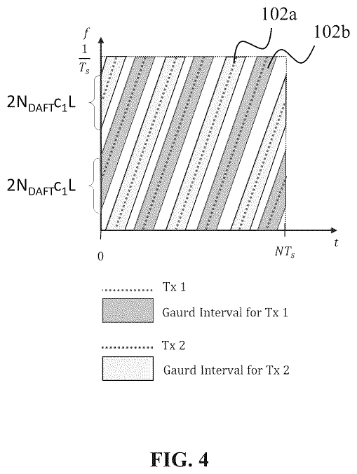

The sensing device transmitter 106 may comprise multiple transmit antennas that generate an AFDM signal 101 where the orthogonality needed for MIMO sensing is achieved by means of DAFT-domain multiplexing i.e., assigning different chirp carriers to the different antennas or spatial beams jointly formed by these antennas, each chirp carrier surrounded in the DAFT domain with a sufficient number of zero guard samples, for example, as shown in FIG. 4 for the case of two sensing antennas or two spatial beams.

FIG. 4 shows AFDM-based sensing in the case of two transmitters according to this disclosure. For example, the two transmitters may be 2×2 MIMO or 2 radar transmitters.

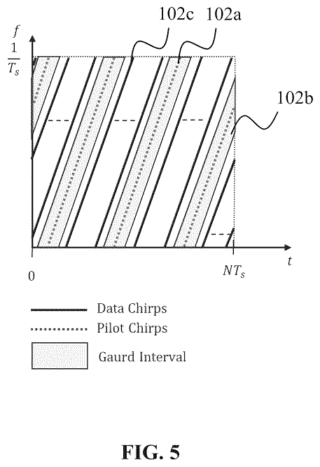

FIG. 5 shows a time-frequency representation of an AFDM-based ISAC waveform according to this disclosure.

FIG. 5 shows data chirps associated with the third subset of chirp carriers 102c, pilot chirps associated with the first subset of chirp carriers 102a, and guard intervals surrounding said pilot chirps, wherein the guard intervals are associated with the second subset of chirp carriers 102b.

DAFT-domain orthogonality may be used to multiplex sensing signals with data symbols either destined to the network (uplink), from the network to the sensing devices 100 (downlink), or from one sensing device 100 to another sensing device 100 (sidelink).

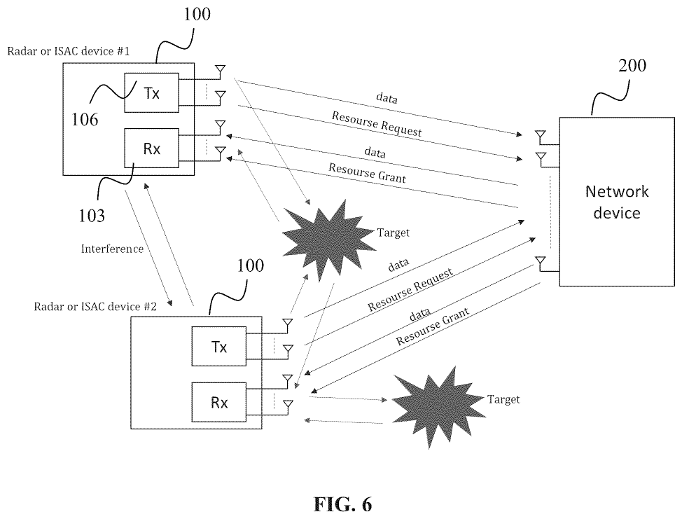

FIG. 6 shows a wireless communication system according to this disclosure. The system may also be referred to as a network. The system comprises a network device 200 and a number of sensing devices 100, wherein some of said sensing devices may be an ISAC device, i.e., also capable of communications. At least some of the signals transmitted by the different components of the system are AFDM signals 101, which may be based on N_{DAFT}-point (c₁, c₂)-DAFT with

$${c}_{1} = ∓ \frac{1 + 2 Q}{2 {N}_{DAFT}} ,$$

wherein Q may be a system parameter that can be set by the network device 200 and broadcasted so that the sensing devices 100 can obtain its value.

The network device 200 may be a network node. The network device 200 may be a base station or an access point. The two or more sensing devices 100 may be ISAC devices.

By coordinating the sensing device transmitters 106 of the sensing devices 100, for example, the AFDM signals 101 of the sensing device transmitters 106, with the network device 200, interference between signals 101 of said sensing device transmitters 106 can be reduced or minimized.

For example, the network device 200 may be configured to at least one of: transmit a periodic or continuous synchronization signal that may for example be an AFDM signal 101; receive sensing resource request messages from one or more of the above sensing devices 100; and send sensing resource assignment/allocation control messages to the one or more sensing devices 100 assigning them the indexes of the non-zero entries at the input to their respective IDAFT modules.

The timing of the AFDM signals 101 transmitted by the one or more sensing device transmitters 106 may be determined based on the synchronization signal periodically or continuously transmitted by the network device 200.

The sensing resource request messages may be sent using a fourth subset of the set of chirp carriers 102 of the AFDM signal 101, for example, a fourth subset of the inputs to the IDAFT module of a respective sensing device transmitter 106. Sensing chirp carriers and/or resource request chirp carriers may be multiplexed at the input to an IDAFT module of the respective sensing device transmitter 106 with data carrying chirp carriers destined either to the network node or to other sensing devices 100.

Each sensing device 100 may further estimate a range and or velocity of a target in its vicinity.

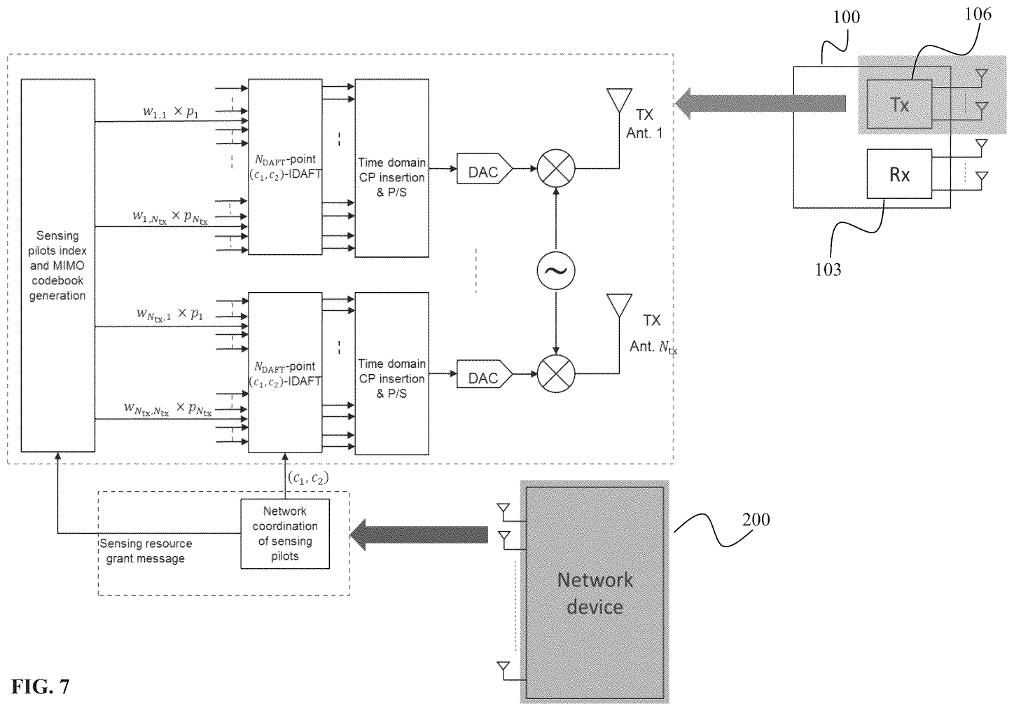

FIG. 7 shows AFDM MIMO sensing device transmitter 106 architecture for sensing and/or integrated sensing and communications according to this disclosure. The sensing device transmitter 106 may generate the AFDM signal 101 based on the modules and elements shown in FIG. 7. In a final step the sensing device transmitter 106 may transmit the generated AFDM signal 101 based on corresponding antennas. For example, the sensing device transmitter 106 comprises Nₜₓ antennas for transmission (transmit antennas), wherein Nu may be a positive integer. The AFDM MIMO sensing device transmitter 106 comprises a first module for sensing pilots index generation and MIMO codebook generation. The AFDM MIMO sensing device transmitter 106 may further comprise two or more IDAFT modules, which perform IDAFT based on a pair of DAFT parameters (c₁, c₂) 104. The pair of DAFT parameters 104 may be provided to the two or more IDAFT modules from a coordination module for network coordination of sensing pilots. The coordination module may be comprised in the sensing device transmitter 106. The coordination module may receive the pair of DAFT parameters 104 from a network device 200 external to the sensing device transmitter 106.

The input samples represented with continuous lines from the first module to respective IDAFT modules are the exemplary chirp carrier pilots used for sensing. The other input samples that are shorter are exemplary guard samples or data symbols.

The coefficients {w_{1,j}, . . . , w_{N}_{ₜₓ}_{,j}} represent the entries of the beamforming vector applied to the j-th DAFT-domain sensing pilot pⱼ. In FIG. 7, only a digital implementation of MIMO precoding is given. This is only one example as analog or hybrid digital-analog architectures are also possible.

Further, FIG. 7 shows two or more time domain CP insertion & and P/S modules for the two or more IDAFT modules. “P/S” stands for a “parallel-to-serial” operation i.e., for transmitting the entries of a vector sequentially in time. “CP insertion” stands for cyclic-prefix insertion. Further, the sensing device transmitter 106 may perform digital-to-analog conversion (DAC) after said modules.

The sensing device transmitter 106 may comprise multiple transmit antennas and multiple IDAFT modules the number of which is equal to or smaller than the number of these antennas, wherein sensing signals may be generated each using one of the IDAFT modules fed with a different weighting of the same vector of complex values. Said vector contains at least a number of non-zero entries equal to the number of IDAFT modules and/or may comprise a set of input symbols. The output of each of the IDAFT modules may be fed, after digital-to-analog conversion and frequency up-conversion, to the input of an analog adder at the input of one or more of the transmit antennas.

In the case of AFDM based on DAFT with

$${c}_{1} = ∓ \frac{1 + 2 q}{2 {N}_{DAFT}}$$

with q<Q (where Q is the maximum Doppler shift in samples corresponding to the maximum target relative velocity to be supported), achieving the same sensing performance requires the use of multiple pilot chirps per antenna or per spatial beam instead of one pilot chirp in the case of DAFT with

$${c}_{1} = ∓ \frac{1 + 2 Q}{2 {N}_{DAFT}} .$$

AFDM based of DAFT with

$${c}_{1} = ∓ \frac{1 + 2 q}{2 {N}_{DAFT}}$$

yields fewer measurements per pilot transmission compared to AFDM based on DAFT with

$${c}_{1} = ∓ \frac{1 + 2 Q}{2 {N}_{DAFT}} ,$$

i.e., AFDM based on DAFT with

$${c}_{1} = ∓ \frac{1 + 2 Q}{2 {N}_{DAFT}}$$

achieves the full diversity order of LTV channels while AFDM based on DAFT with

$${c}_{1} = ∓ \frac{1 + 2 q}{2 {N}_{DAFT}}$$

does not. The use of M AFDM pilot chirps instead of one AFDM pilot chirp may not entail an increase in total pilot overhead. One pilot symbol of AFDM with

$${c}_{1} = ∓ \frac{1 + 2 Q}{2 {N}_{DAFT}}$$

may require more guard samples than one pilot symbol of AFDM with

$${c}_{1} = ∓ \frac{1 + 2 q}{2 {N}_{DAFT}}$$

when q<Q que to the larger effective (in DAFT-domain) delay spread of the former compared to the latter.

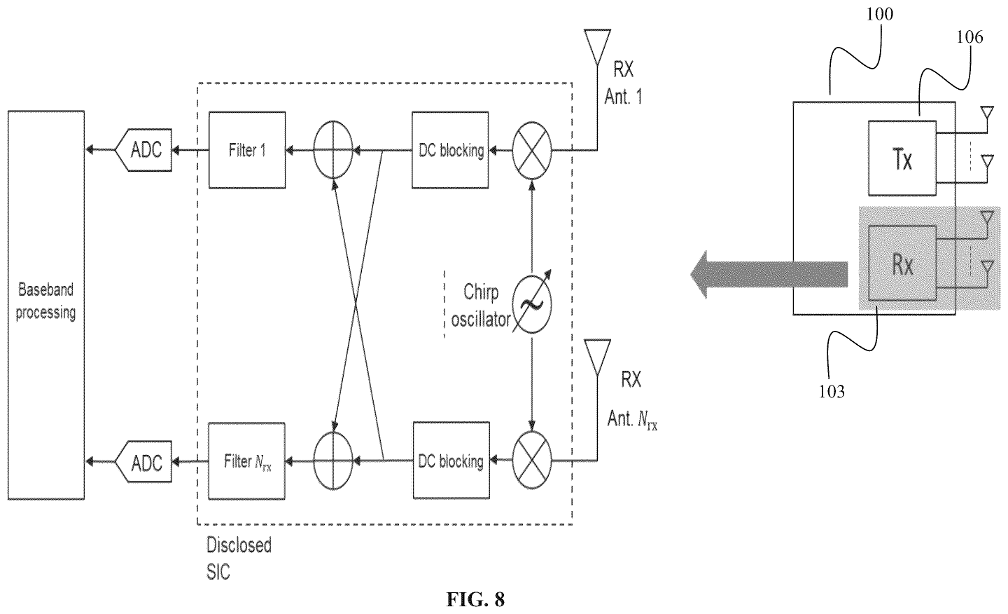

FIG. 8 shows a sensing device receiver 103 according to this disclosure. Each sensing device transmitter 106 and/or the network device 200 may comprise a sensing device receiver 103. The sensing device receiver 103 may receive an AFDM signal 101 from a sensing device transmitter 106 and/or a network device 200. For example, the sensing device receiver 103 may be a sensing device receiver 103 part of the sensing device transmitter 106 of FIG. 7. The sensing device receiver 103 may comprise Nᵣₓ sensing device receiver 103 antennas for receiving the AFDM signal 101, wherein Nᵣₓ may be a positive integer. The Nᵣₓ sensing device receiver 103 antennas may be a plurality of sensing device receiver 103 antennas. The Nᵣₓ sensing device receiver 103 antennas may comprise physical antennas and/or antenna ports.

A step, for example a first step, of receiving an AFDM signal 101 with the sensing device receiver 103 may be a de-chirping operation. This has the advantage of enabling low-cost self-interference cancellation.

If the AFDM signal 101 is generated using a

$$( ∓ \frac{1}{2 {N}_{DAFT}} , ∓ \frac{1}{2 {N}_{DAFT}} ) - DAFT$$

(instead of AFDM generated using a

$$( ∓ \frac{1 + 2 Q}{2 {N}_{DAFT}} , ∓ \frac{1}{2 {N}_{DAFT}} ) - DAFT ) ,$$

the sensing device receiver 103 architecture of FIG. 8 may involve higher hardware complexity in the case of AFDM based on a

$$( ∓ \frac{1}{2 {N}_{DAFT}} , ∓ \frac{1}{2 {N}_{DAFT}} ) - DAFT$$

as compared to AFDM based on a

$$( ∓ \frac{1 + 2 Q}{2 {N}_{DAFT}} , ∓ \frac{1}{2 {N}_{DAFT}} ) - DAFT .$$

Indeed, the analog filter block per branch of the architecture of FIG. 8 would need to be replaced by a splitter followed by M analog filters so that the echoes resulting from each of the M pilot chirps are received without direct-path self-interference.

For the sensing device receiver 103, there is no need for analog cancellation of the direct-path self-interference using costly full-duplex methods. This is an advantage over OFDM or OTFS based ISAC solutions.

The sensing device receiver 103 antennas may be connected to an RF down-converter fed with a chirp local oscillator generating periodic chirp segments that are synchronized with the AFDM symbols transmitted by the sensing device transmitter 106 in a way that the chirp segment coincides in time and frequency with a reference chirp defined as one of the chirp carriers of the transmitted AFDM signal 101. The RF down-converter may generate a down-converted output.

Further, a DC blocking module may be connected to the output of the down-converter to remove direct-path interference resulting from the part of the transmitted signal modulating the reference chirp. The DC blocking module may be configured to block the DC component of the down-converted output to generate a blocked output.

Further, a continuous-time (analog) filter may be connected to the output of the DC blocking module and tuned to remove direct-path interference resulting from the part of the transmitted signal modulating the other sensing chirps and the chirps carrying data and control symbols. The continuous-time filter may be configured to filter the blocked output to generate the output signal. The continuous time filter may comprise Nᵣₓ respective filters, for example, one filter for each sensing device receiver 103 antenna. Further, FIG. 8 shows analog to digital conversion for each respective filter and a baseband processing module.

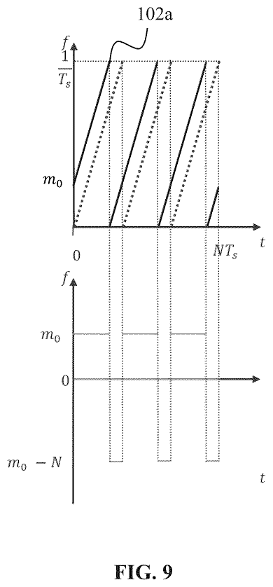

FIG. 9 shows a time-frequency representation of an exemplary output of analog de-chirping in the case of an AFDM signal 101 with two active chirp sub-carriers (chirp subcarrier 0 and chirp subcarrier m₀∈{1, . . . , N_{DAFT}−1}) according to this disclosure. In this example, the chirp sub-carriers were generated using DAFT with

$${c}_{1} = \frac{1 + 2 Q}{2 {N}_{DAFT}}$$

and Q=1 and the de-chirping is done using one of said two chirp carriers as a reference chirp. The y-axis of the bottom figure of FIG. 9 is in normalized frequencies. As show in FIG. 9, the self-interference related to the reference chirp itself may appear after de-chirping at the zero frequency and can hence be cancelled using by DC blocking. Further, the self-interference related to the other chirp appears as segments of complex exponential signals with deterministic frequencies related to the difference in samples between the DAFT-domain indexes of the two chirp carriers. This interference can be eliminated with an analog lowpass filter.

AFDM based devices gain in resource utilization over FMCW based devices in the multi-antenna or multi-radar case while having the same simple SIC property and the same resolution as FMCW due to the “analog” nature of FMCW. In ISAC scenarios, AFDM based devices also achieve better spectral efficiency for data transmission compared to FMCW based devices where the communications signal carrying data is time-division or frequency-division multiplexed with a radar signal because in such schemes the portion of the time-frequency resources occupied by the sensing signal (and thus not carrying data) is larger compared to embodiments of this disclosure. Hence, embodiments of this disclosure provide an improved data spectral efficiency. Further, neither OFDM nor OTFS based sensing or integrated sensing and communications can offer the self-interference cancellation feature of AFDM.

Each sensing device 100, each sensing device transmitter 106, each sensing device receiver 103, and/or the network device 200 according to this disclosure may comprise a respective processor for controlling said respective device. A sensing device receiver 103 comprised in a sensing device 100 or a network device 200 may share a processor with a sensing device transmitter 106 of the sensing device 100 or network device 200. For example, a network according to this disclosure may comprise three or more processors. A sensing device transmitter 106 may comprise a first processor, a sensing device receiver 103 may comprise a second processor, and/or a network device 200 may comprise a third processor.

Generally, the first processor may be configured to perform, conduct or initiate the various operations of the sensing device transmitter 106 described herein. The first processor may comprise hardware and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The sensing device transmitter 106 may further comprise memory circuitry, which stores one or more instruction(s) that can be executed by the first processor, in particular under control of the software. For instance, the memory circuitry may comprise a non-transitory storage medium storing executable software code which, when executed by the first processor, causes the various operations of the sensing device transmitter 106 to be performed. In one embodiment, the sensing device transmitter 106 may comprises one or more first processors and a non-transitory memory connected to the one or more first processors. The non-transitory memory may carry executable program code which, when executed by the one or more first processors, causes the sensing device transmitter 106 to perform, conduct or initiate the operations or methods described herein.

Generally, the second processor may be configured to perform, conduct or initiate the various operations of the sensing device receiver 103 described herein. The second processor may comprise hardware and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The sensing device receiver 103 may further comprise memory circuitry, which stores one or more instruction(s) that can be executed by the second processor, in particular under control of the software. For instance, the memory circuitry may comprise a non-transitory storage medium storing executable software code which, when executed by the second processor, causes the various operations of the sensing device receiver 103 to be performed. In one embodiment, the sensing device receiver 103 may comprises one or more second processors and a non-transitory memory connected to the one or more second processors. The non-transitory memory may carry executable program code which, when executed by the one or more second processors, causes the sensing device receiver 103 to perform, conduct or initiate the operations or methods described herein.

Generally, the third processor may be configured to perform, conduct or initiate the various operations of the network device 200 described herein. The third processor may comprise hardware and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The network device 200 may further comprise memory circuitry, which stores one or more instruction(s) that can be executed by the third processor, in particular under control of the software. For instance, the memory circuitry may comprise a non-transitory storage medium storing executable software code which, when executed by the third processor, causes the various operations of the network device 200 to be performed. In one embodiment, the network device 200 may comprises one or more third processors and a non-transitory memory connected to the one or more third processors. The non-transitory memory may carry executable program code which, when executed by the one or more third processors, causes the network device 200 to perform, conduct or initiate the operations or methods described herein.

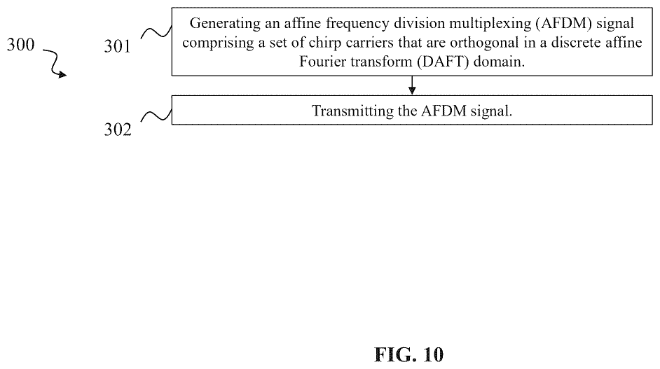

FIG. 10 shows a method 300 according to an embodiment of this disclosure. The method 300 may be performed by the sensing device transmitter 106. The method 300 comprises a step 301 of generating an AFDM, signal comprising a set of chirp carriers 102 that are orthogonal in a DAFT domain. Further, the method 300 comprises a step 302 of transmitting the AFDM signal 101.

Generally, the set of chirp carriers 102 is generated based on an IDAFT and the set of chirp carriers 102 comprises a first subset of chirp carriers 102a that are pilot signals for sensing, and a second subset of chirp carriers 102b that are nulled.

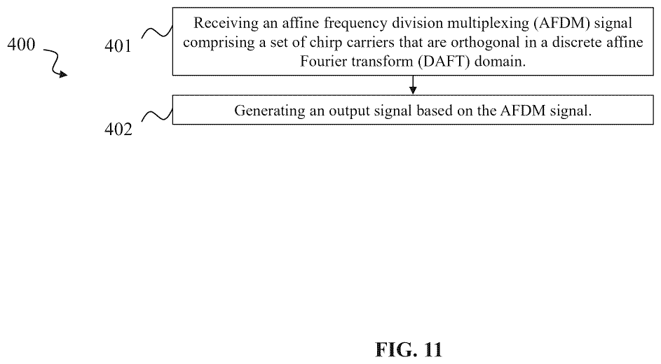

FIG. 11 shows a method 400 according to an embodiment of this disclosure. The method 400 may be performed by the sensing device receiver 103. The method 400 comprises a step 401 of receiving an AFDM signal 101 comprising a set of chirp carriers 102 that are orthogonal in a DAFT domain. Further, the method 400 comprises a step 402 of generating an output signal based on the AFDM signal 101.

Generally, the set of chirp carriers 102 comprises a first subset of chirp carriers 102a that are pilot signals for sensing, and a second subset of chirp carriers 102b that are nulled.

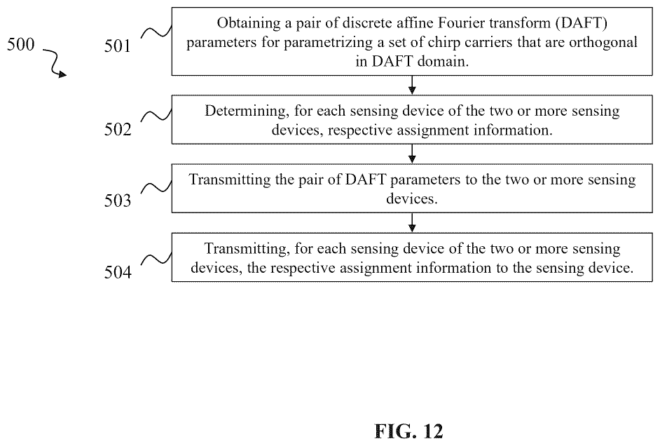

FIG. 12 shows a method 500 according to an embodiment of this disclosure. The method 500 may be performed by the network device 200. The method 500 comprises a step 501 of obtaining a pair of DAFT parameters 104 for parametrizing a set of chirp carriers 102 that are orthogonal in DAFT domain. Further, the method 500 comprises a step 502 of determining, for each sensing device 100 of the two or more sensing devices 100, respective assignment information 105. Further, the method 500 comprises a step 503 of transmitting the pair of DAFT parameters 104 to the two or more sensing devices 100. Further, the method 500 comprises a step 504 of transmitting, for each sensing device 100 of the two or more sensing devices 100, the respective assignment information 105 to the sensing device 100.

Generally, the method 500 is for coordinating a network of two or more sensing devices 100, and for each sensing device 100 of the two or more sensing devices 100, the respective assignment information 105 indicates a partition of the set of chirp carriers 102 into at least a first subset of chirp carriers 102a that are pilot signals for sensing, and a second subset of chirp carriers 102b that are nulled.

The disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A sensing device transmitter (106), wherein the sensing device transmitter (106) is configured to
generate an affine frequency division multiplexing, AFDM, signal (101) comprising a set of chirp carriers (102) that are orthogonal in a discrete affine Fourier transform, DAFT, domain, and
transmit the AFDM signal (101),
wherein the set of chirp carriers (102) is generated based on an inverse discrete affine Fourier transform, IDAFT, and
wherein the set of chirp carriers (102) comprises a first subset of chirp carriers (102a) that are pilot signals for sensing, and a second subset of chirp carriers (102b) that are nulled.

2. The sensing device transmitter (106) according to claim 1,
wherein the set of chirp carriers (102) further comprises a third subset of chirp carriers (102c) for data transmission and/or control messages transmission.

3. The sensing device transmitter (106) according to claim 1, configured to
obtain a pair of DAFT parameters (104) for parametrizing the set of chirp carriers (102),
wherein the AFDM signal (101) is generated further based on the pair of DAFT parameters (104).

4. The sensing device transmitter (106) according to claim 1, configured to
obtain a pair of DAFT parameters (104) and/or assignment information (105), and
determine at least two of: the first subset of chirp carriers (102a), the second subset of chirp carriers (102b), and the third subset of chirp carriers (102c), based on the assignment information (105) and/or the pair of DAFT parameters (104).

5. The sensing device transmitter (106) according to claim 3:
wherein the pair of DAFT parameters (104) comprises a first parameter, which indicates a slope of the chirp carriers of the set of chirp carriers (102), the slope being defined by a linear frequency variation of each chirp carrier of the set of chirp carriers (102) over time.

6. The sensing device transmitter (106) according to claim 3, wherein the sensing device transmitter (106) is configured to:
obtain a set of input symbols comprising at least two of a first subset of pilot symbols, a second subset of null symbols, and a third subset of data symbols,
map the set of input symbols to the set of chirp carriers (102) parametrized with the pair of DAFT parameters (104) by applying the IDAFT.

7. The sensing device transmitter (106) according to claim 6,
wherein each input symbol of the first subset of pilot symbols corresponds to a chirp carrier of the first subset of chirp carriers (102a) and is surrounded in the DAFT domain by a number of null symbols of the second subset of null symbols corresponding to the second subset of chirp carriers (102b) forming a respective buffer interval for the chirp carrier of the first subset of chirp carriers (102a).

8. The sensing device transmitter (106) according to claim 7, wherein the number of null symbols for each input symbol from the first subset of pilot symbols is equal to at least 2N_{DAFT}c₁(L−1)+2Q,
wherein L−1 is a round-trip delay in samples associated with a target at the maximum range to be supported by the sensing device transmitter (106),
wherein a first parameter of the pair of DAFT parameters (104) is
$${c}_{1} = \frac{1 + 2 Q}{2 {N}_{DAFT}} ,$$
wherein Q is a normalized Doppler frequency shift in samples associated with a target at the maximum relative speed with the sensing device transmitter (106) to be supported by that device,
wherein N_{DAFT} is a predetermined system parameter equal to the size of the DAFT which is also a number of chirp carriers of the set of chirp carriers (102).

9. The sensing device transmitter (106) according to claim 1,
wherein the sensing device transmitter (106) comprises a plurality of transmit antennas,
wherein the sensing device transmitter (106) is configured to assign each chirp carrier of the first subset of chirp carriers to a different antenna of the plurality of antennas and/or to a different spatial beam jointly formed by said plurality of antennas to be transmitted exclusively through said antenna or said spatial beam.

10. The sensing device transmitter (106) according to claim 1, configured to transmit a sensing resource request message to a network device (200), and receive the pair of DAFT parameters (104) and/or the assignment information (105) as a response to the request.

11. A sensing device receiver (103), wherein the sensing device receiver (103) is configured to:
receive an affine frequency division multiplexing, AFDM, signal comprising a set of chirp carriers (102) that are orthogonal in a discrete affine Fourier transform, DAFT, domain, wherein the set of chirp carriers (102) comprises a first subset of chirp carriers (102a) that are pilot signals for sensing, and a second subset of chirp carriers (102b) that are nulled; and
generate an output signal based on the AFDM signal (101).

12. The sensing device receiver (103) according to claim 11,
wherein the sensing device receiver (103) is further configured to
obtain a chirp local oscillator,
down-convert the AFDM signal (101) using the chirp local oscillator to generate a down-converted output that is based on at least the first subset of chirp carriers (102a),
direct current, DC, block the down-converted output to generate a blocked output,
wherein the sensing device receiver (103) further comprises a continuous-time filter configured to filter the blocked output to generate the output signal.

13. The sensing device receiver (103) according to claim 11,
wherein the AFDM signal (101) is received through at least one channel, and
wherein the sensing device receiver (103) is further configured to generate channel estimation information of the at least one channel based on the output signal.

14. The sensing device receiver (103) according to claim 13,
wherein the receiver (103) is further configured to generate, with the at least one channel, range and/or relative speed estimates about one or more targets in an environment surrounding the receiver (103) based on the channel estimation information.

15. The sensing device receiver (103) according to claim 11,
wherein the set of chirp carriers (102) further comprises a third subset of chirp carriers (102c) for data transmission and/or control messages transmission.

16. The sensing device receiver (103) according to claim 12,
wherein the AFDM signal (101) comprises a set of AFDM multi-chirp symbols,
wherein the sensing device receiver (103) comprises
a radio frequency, RF, down-converter configured to down-convert the AFDM signal (101), and
wherein the sensing device receiver (103) is configured to:
designate one chirp carrier of the set of chirp carriers (102) as a reference chirp carrier,
wherein the chirp local oscillator comprises a set of periodic chirp segments, wherein each chirp segment of the set of periodic chirp segments is synchronized in time and frequency with the reference chirp carrier in one AFDM symbol of the set of AFDM multi-chirp symbols,
feed the RF down-converter with the chirp local oscillator to generate a set of multi-frequency-tone signal segments, each segment of the set of multi-frequency-tone signal segments corresponding to an AFDM symbol of the set of AFDM multi-chirp symbols, and
block the DC component of the down-converted output to remove or attenuate direct-path interference resulting from a part of the AFDM signal (101) modulating the reference chirp carrier,
wherein the continuous-time filter is configured to filter the blocked output to remove or attenuate direct-path interference corresponding to tones of the down-converted output resulting from a part of the AFDM signal (101) modulating other chirp carriers of the set of chirp carriers (102).

17. A network device (200) for coordinating a network of two or more sensing devices (100), wherein the network device (200) is configured to:
obtain a pair of discrete affine Fourier transform, DAFT, parameters (104) for parametrizing a set of chirp carriers (102) that are orthogonal in DAFT domain,
determine, for each sensing device (100) of the two or more sensing devices (100), respective assignment information (105),
transmit the pair of DAFT parameters (104) to the two or more sensing devices (100),
transmit, for each sensing device (100) of the two or more sensing devices (100), the respective assignment information (105) to the sensing device (100),
wherein, for each sensing device (100) of the two or more sensing devices (100), the respective assignment information (105) indicates a partition of the set of chirp carriers (102) into at least a first subset of chirp carriers (102a) that are pilot signals for sensing, and a second subset of chirp carriers (102b) that are nulled.

18. The network device (200) according to claim 17, wherein, for each sensing device (100) of the two or more sensing devices (100), the respective assignment information (105) indicates a partition of the set of chirp carriers (102) into at least the first subset of chirp carriers (102a), the second subset of chirp carriers (102b), and a third subset of chirp carriers (102c) for data transmission and/or control messages transmission.

19. The network device (200) according to claim 17, wherein, for each sensing device (100) of the two or more sensing devices (100), the first subset of chirp carriers (102a) is entirely different from at least one of: a respective first subset of chirp carriers (102a) of each other sensing device (100) of the two or more sensing devices (100), and a respective third subset of chirp carriers (102c) of each other sensing device (100) of the two or more sensing devices (100).

20. The network device (200) according to any one of the claim 17, configured to
receive a sensing resource request message from at least one sensing device (100) of the two or more sensing devices (100),
obtain the pair of DAFT parameters (104) and/or determine the assignment information (105) as a response to the sensing resource request message.
